(19) United States
(12) Patent Application Publication
(10) Pub. No.: US 2005/0068777 A1
(43) Pub. Date: Mar. 31, 2005

(54) Modular LED light and method

(76) Inventor: Dragoslav Popovic, Germantown, WI (US)

Correspondence Address: QUARLES & BRADY LLP, 411 E. WISCONSIN AVENUE, SUITE 2040, MILWAUKEE, WI, 53202-4497, US

(21) Appl. No.: 10/670,702

(22) Filed: Sep. 25, 2003

(51) Int. Cl. F21V 7/00

(52) U.S. Cl. 362/307

(57) ABSTRACT

An at least partially translucent optical element for distributing light from a light source, the element comprising a hub member formed about a central axis, having an external surface between first and second ends and forming a recess within the first end that extends along the central axis substantially along a length of the hub member between the first and second ends for receiving the source, the external surface forming a lens for dispersing light directed thereat from within the recess out of the element and a reflecting member integral with and extending from the second end, the reflecting member including at least one external reflecting surface that reflects substantially all of the light directed into the reflecting member from within the recess back into the element.

### CROSS-REFERENCE TO RELATED APPLICATION

Not applicable.

### STATEMENT OF FEDERALLY SPONSORED RESEARCH OR DEVELOPMENT

Not applicable.

### BACKGROUND OF THE INVENTION

1. Technical Field

The present invention relates to lighting devices and, more specifically, to lighting devices having light emitting diodes coupled with optical elements for radially projecting light.

2. Description of the Related Art

Strobe lights, warning beacons and other lighting devices for commercial, industrial, military, law enforcement or other such applications typically include a light bulb (e.g., incandescent or xenon bulb) disposed inside of a translucent housing and associated electronics that drive the bulb in steady or pulsed operation. Often one or more reflectors are placed in the housing to focus or disperse the light emitted from the light bulb in a radially directed pattern. Hereinafter, unless indicated otherwise, strobe configurations that include bulbs will be referred to as bulb type devices. In addition, flashing lights generally will be referred to hereinafter as strobe lights unless indicated otherwise.

While bulb type devices have been used for many years and are suitable for many applications, these devices have many shortcomings. First, in addition to generating light, bulb type devices also generate a relatively large quantum of heat which is dissipated as wasted energy. Thus, bulb type devices are less than optimally efficient.

While inefficient bulb type devices are suitable for some applications where energy is effectively inexhaustible, in other applications energy available is limited and device efficiency is important. For instance, in the case of a temporary construction sign on the side of a road that requires a strobe light, often a generator or a battery pack is the only source of available energy. As another instance, many lift trucks, carts and the like that include strobe lights are battery powered. In these cases the energy source is limited and efficient energy use is particularly important.

Second, some bulb type devices (e.g., xenon bulbs) produce significant electromagnetic interference (“EMI”). As well known in the electronics industry, EMI disturbs proximate electronics in both the strobe light and other electronics proximate the light. In fact, EMI emissions have become so troublesome in some applications that many municipalities now regulate EMI emission levels from strobe lights and other types of electronic devices. Where expected EMI emissions from a bulb are potentially high, strobe lights have to be designed to shield the emissions from emanating from the light structure which increases overall light costs.

Third, the useful life of an incandescent bulb or a xenon bulb is relatively short (i.e., the bulbs burn out) and the bulbs routinely have to be replaced. Replacement is costly in terms of materials as well as maintenance time and, in many cases, downtime as a vehicle operator on which a bulb burns out may have to halt work and replace the bulb to conform to safety requirements. Exacerbating matters further, the useful life of a bulb is usually shorted when a bulb type device is mounted to a vehicle, a machine, or the like that vibrates during use. Here, the vibrations have been known to degrade filament integrity expeditiously.

Fourth, because bulbs have to be routinely replaced on bulb type devices, the bulb type devices have to be designed so that the housing can be dis-assembled to facilitate replacement. The disassembly requirement increases costs generally and, in addition, results in a lighting configuration where it is relatively difficult to form a complete hermetic seal about the bulb and the driving electronics. While an elastomeric sealing ring or the like can be provided to help overcome this limitation, the ring represents additional cost and, if aligned improperly during assembly or maintenance, can result in a semi-exposed bulb which can further expedite bulb (and electronics) deterioration.

Fifth, most bulb type devices are designed for specific purposes and their components cannot be swapped out easily to configure lighting devices useable for other applications. For example, some applications require illumination intensities that fall with particular Society of Automotive Engineers (SAE) classifications (e.g., categories 1, 2 and 3 where each category indicates a specific light intensity requirement). As another example, many strobe light applications require an omni-directional or 360 degree radial spatial light dispersion pattern. In the case of a bulb type lighting device, typically, to move from one lighting category to the next, all of the electronics, the filament and many other components have to be replaced. Separate components for each lighting requirement increases the costs of providing any one of the bulb type devices as device components cannot be standardized among devices.

To address several of the problems above, some lighting devices have been designed that employ light emitting diodes (“LEDs”) instead of light bulbs. In this regard, LEDs consume considerably less power than light bulbs, produce essentially no EMI and, in many cases, have an essentially infinite useful life such that they do not have to be replaced. Because LEDs needn't be replaced, maintenance costs and costs associated with employee down time due to a burnt our bulb can be minimized.

Unfortunately, typical LEDs have a lighting pattern that does not emit enough light radially to meet SAE requirements. For this reason, in order to meet the SAE requirements, exemplary LED type lighting devices typically include an array of LEDs (e.g., on the order to tens to hundreds). The LED array is typically arranged with respect to one or more reflective covers to facilitate 360 degree light dispersion. For several examples of LED type devices that require an array of LEDs see U.S. Pat. Nos. 5,608,290; 5,929,788; and 6,183,100. In some cases LED arrays have been mounted on a cylindrical substrate so that light from the LEDs is emitted essentially omni-directionally. In this regard see U.S. Pat. No. 5,806,965.

While LED type devices solve some of the problems associated with bulb type devices, unfortunately, LED type devices also have shortcomings. To this end, as with most products, in the case of an LED type lighting device, increased parts count to provide an array of LEDs and support structure increases device costs appreciably.

In addition, as parts count increases, assembly costs also increase and the likelihood of faulty assembly is increased. Moreover, while each LED may draw less power than the bulbs described above, as the number of LEDs is increased to meet illumination requirements, the power required to drive the device is also increased. Furthermore, as more power is consumed, the LEDs generate more heat and special heat dissipating structures are required which further increases costs and limits array arrangements (i.e., limits how closely LEDs can be packed together to provide required illumination).

U.S. Pat. No. 6,543,911 (hereinafter “the '911 patent”) discloses a lighting device for use in surface marking road lanes and the like that, in at least one embodiment, utilizes a single LED. The single LED device described in the '911 patent includes a base member that forms an LED receiving well having an upward facing surface and a reflector or “light transformer” lens thereabove that defines an interior aspherical reflective surface that faces the upward facing surface of the well. The LED is centrally mounted within the well along a central vertical axis that is concentric with the reflective surface and so that a portion of the light generated thereby emanates generally upward toward the reflective surface. The light directed at the reflective surface is redirected generally radially. The '911 patent claims that approximately 70% of the light generated by the LED is directed along trajectories that are essentially perpendicular to the central axis while the other 30% of LED light is directed along other trajectories that form an acute angle with the central axis.

While the '911 patent device described above radially disperses a greater percentage of generated light and uses less power than other known LED type devices, even this device falls short of optimal operating characteristics. For instance, as indicated above and as described in the '911 patent, 30% of the light generated by the '911 device is along trajectories that form acute angles with the central axis so that a large percent of the generated light is effectively wasted. It is believed that the 70% figure regarding radially directed light offered in the '911 patent is generous. In this regard, it is noted that LEDs direct at least some light laterally (e.g., 25%). When an LED is placed within a base member well as taught in the '911 patent, most of the laterally directed light would be absorbed within the base member and would never emanate from the device. Assuming 25% of LED generated light is absorbed within the well and that 70% of the remaining 75% of the LED light is directed along trajectories perpendicular to the central axis, the total light directed radially and useful for strobe light devices would be just over 50%. Thus, in a practical design consistent with the teaches of the '911 patent only approximately 50% of light emitted from the single LED design is radially directed and useful for strobe light purposes.

Also, in this regard, while the '911 patent teaches that a majority of LED emitted light is directed along trajectories perpendicular to the central axis and that lesser amounts of light is directed along trajectories that are acute with respect to the central axis, it is believed that just the opposite effect may result from the reflective surface taught in the '911 patent. Here, it is recognized that the majority of LED light generated is directed along the central axis and the intensity of light rays falls off to the sides thereof. The '911 patent teaches that light along the central axis is directed along the acute trajectories while the less intense light along trajectories that diverge form the central axis reflect from the reflective surface along the perpendicular trajectories. Thus, while the 70% number taught in the '911 patent is assumed above, even this number is questionable.

In addition, 50% of the light generated by most LEDs and spread out over 360 degrees will not meet even the lowest SAE light emitting requirements. Thus, while the '911 patent device may be suitable for road lane marking, unless a relatively expensive and high power LED is employed, such a device may not be useful for strobe light applications.

### SUMMARY OF THE INVENTION

It has been recognized that simple light modules can be configured that direct almost all light emitted by a light emitter radially through a light guide and that the intensity of the resulting light can be sufficient in some cases to meet SAE intensity standards for flashing lights. It has also been recognized that, even in cases where a specific SAE standard cannot be met with a single light emitter module, two or more modules can be stacked together to, in combination, generate enough light to meet SAE standards. Moreover, it has been recognized that a simple housing configuration can be used to hold modules together in a stacked fashion in a simple, inexpensive and aesthetically pleasing manner. Furthermore, it has been recognized that electrical leads to provide currents to the modules can be staggered angularly about a central axis of the modules to avoid problems associated with staging modules and to therefore provide strobe type lights where light intensity is essentially uniform from all angels about the light assembly.

Consistent with the above, at least some embodiments of the invention include an at least partially translucent optical element for distributing light from a light source, the element comprising a hub member formed about a central axis, having an external surface between first and second ends and forming a recess within the first end that extends along the central axis substantially along a length of the hub member between the first and second ends for receiving the source, the external surface forming a lens for dispersing light directed thereat from within the recess out of the element and a reflecting member integral with and extending from the second end, the reflecting member including at least one external reflecting surface that reflects substantially all of the light directed into the reflecting member from within the recess back into the element.

Some embodiments include an apparatus comprising a substantially translucent element including a plurality of external surfaces including at least one light receiving surface for passing light from a source along a plurality of trajectories into the element, at least a subset of the element surfaces juxtaposed to reflect light received through the receiving surface internally and radially outwardly from a central axis and through at least one lateral surface out of the element, a light source juxtaposed to emit light into the element through the receiving surface when energized, a driving circuit that includes receiving apertures that define a pattern, substantially rigid electrical leads coupled to the source and juxtaposed with respect to each other so that the leads define the same pattern as the receiving apertures such that the leads are receivable within the apertures.

In addition, some embodiments include an apparatus comprising a base member, a translucent cover member securable to the base member so that the base member and cover form a cavity, driving circuitry mounted to the base member, at least one optical module mounted within the cavity, the module including a substantially translucent element including a plurality of external surfaces including at least one light receiving surface for passing light from a source along a plurality of trajectories into the element, at least a subset of the element surfaces juxtaposed to reflect light received through the receiving surface internally and substantially radially outwardly from a central axis and through at least one lateral surface out of the element and a light source juxtaposed to emit light into the element through the receiving surface when energized.

Moreover, some embodiments include an apparatus comprising a base member, a translucent cover member securable to the base member so that the base member and cover form a cavity, driving circuitry mounted to the base member, a plurality of optical modules mounted within the cavity, each module including a substantially translucent element including a plurality of external surfaces including at least one light receiving surface for passing light from a source along a plurality of trajectories into the element, at least a subset of the element surfaces juxtaposed to reflect light received through the receiving surface internally and substantially radially outwardly from a central axis and through at least one lateral surface out of the element, a light source juxtaposed to emit light into the element through the receiving surface when energized and electrical leads linking the source to the driving circuitry.

Furthermore, some embodiments include a method of assembling a modular lighting device comprising the steps of providing a plurality of optical modules, each module including a substantially translucent element including a plurality of external surfaces including at least one light receiving surface for passing light from a source along a plurality of trajectories into the element, at least a subset of the element surfaces juxtaposed to reflect light received through the receiving surface internally and substantially radially outwardly from a central axis and through at least one lateral surface out of the element, the element emitting a known quantum of light through the lateral surface when a light source of specific intensity is juxtaposed to emit light through the receiving surface and a light source of the specific intensity juxtaposed to emit light into the element through the receiving surface when energized, identifying a desired output light intensity to be emitted from the lighting device, selecting a quantity of the optical modules to achieve the desired output light intensity, linking the selected quantity of modules to a driving circuit to provide power thereto and placing a translucent cover over the modules.

In addition, some embodiments include a method of assembling a modular lighting device comprising the steps of providing a plurality of optical modules, each module emitting a known quantum of light along trajectories substantially perpendicular to a central axis and through a lateral surface when power is provided thereto, identifying a desired output light intensity to be emitted from the lighting device, selecting a quantity of the optical modules to achieve the desired output light intensity, stacking the selected modules with their central axis aligned and linking the modules to a power source to provide power thereto.

Moreover, in some cases the invention includes a method of assembling a modular lighting device comprising the steps of providing a plurality of optical modules, each module emitting light along known trajectories, selecting a quantity of the optical modules to achieve the desired lighting effect, stacking the selected modules together in a pattern to achieve the desired lighting effect, linking the modules to a power source to provide power thereto and providing a housing assembly about the stacked modules that compressively holds the modules together in the stacked configuration.

In other cases the invention includes n apparatus comprising a plurality of light sources, each source generating light along trajectories that fan out about a central light axis and a mounting structure for mounting the light sources such that the light axis are parallel to a central axis that has an axis length dimension and such that the sources are adjacent different locations along the axis length dimension.

Furthermore, in some cases the invention includes a method comprising the steps of providing a plurality of light sources, each source, when energized, generating light along trajectories that fan out about a central light axis, mounting the light sources such that the light axis are parallel to a central axis that has an axis length dimension and such that the sources are adjacent different locations along the axis length dimension and linking the sources to a driving circuit to provide power thereto.

In some embodiments the invention includes a strobe light comprising a plurality of LEDs, each LED generating light along trajectories that fan out about a central LED axis, a support structure for mounting the LEDs such that the LED axis are aligned along a central axis, a driving circuit for driving the LEDs, the driving circuit linked to each LED to provide power thereto and a housing assembly including a base member and a cover member that together form a cavity, the LEDs and support structure mounted within the cavity.

These and still other advantages of the invention will be apparent from the detailed description and drawings. What follows is a preferred embodiment of the present invention. To assess the full scope of the invention the claims should be looked to as the preferred embodiment is not intended as the only embodiment within the scope of the invention.

### BRIEF DESCRIPTION OF THE DRAWINGS

FIG. 1 is a front plan view of one LED light embodiment incorporating some of the aspects of the present invention;

FIG. 2 is a cut-away sectional view taken along line 2-2 of FIG. 1;

FIG. 3 is an exploded view in partial cross-section of the in FIG. 2 embodiment;

FIG. 4 is a partially exploded sectional view of one of the optical modules of FIG. 3;

FIG. 5 is a fully exploded sectional view of the LED optical module shown in FIG. 4;

FIG. 6 is a top sectional view taken along line 6-6 of FIG. 2;

FIG. 7 is a bottom sectional view taken along line 7-7 of FIG. 2;

FIG. 8 is a bottom end view of the optical module shown in FIG. 4;

FIG. 9 is an enlarged sectional view of an exemplary optical module showing exemplary light trajectories through the optical element;

FIG. 10 is a top perspective view of the optical element of FIG. 9;

FIG. 11 is a bottom perspective view of the element of FIG. 9;

FIG. 12 is a front plan view similar to FIG. 2 of an alternate embodiment of an LED light having a single optical module and two spacers disposed between the optical module and a cover;

FIG. 13 is a front plan view similar to FIG. 12 of another alternate embodiment of an LED light with a single optical module positioned within smaller sized cover; and

FIG. 14 is a front plan view of an alternate, opposed arrangement of stacking the optical elements.

### DETAILED DESCRIPTION OF THE PREFERRED EMBODIMENT

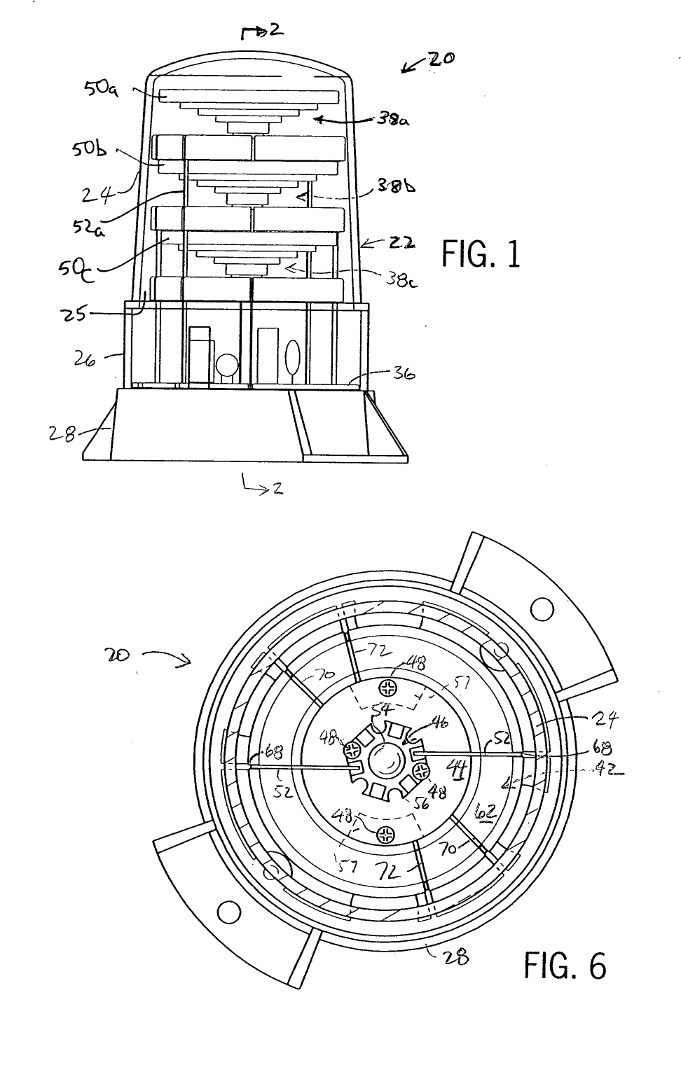

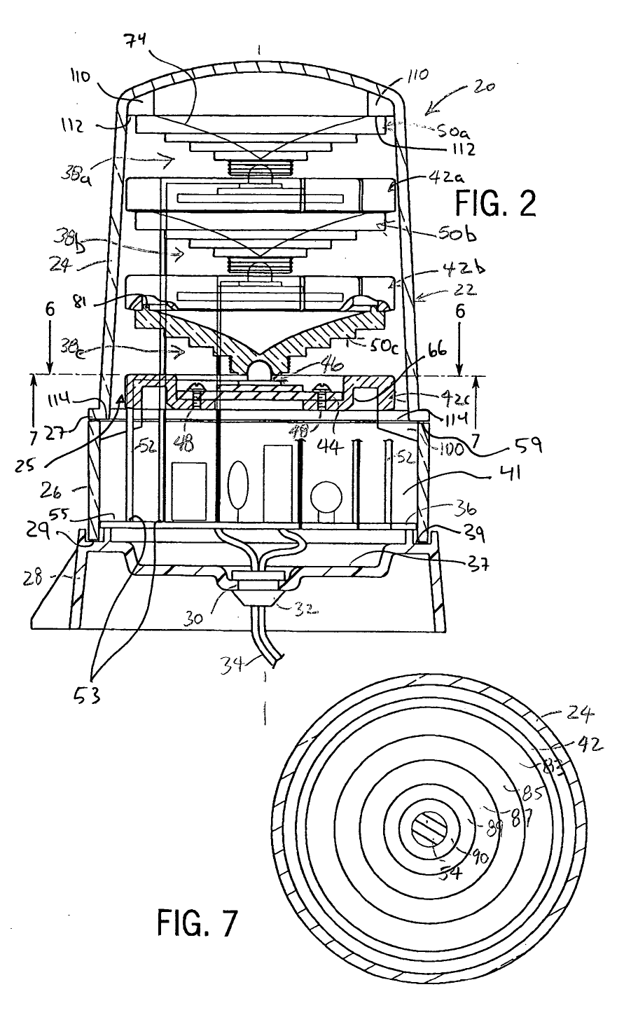

In the description that follows, while the light configurations described may be positioned in virtually any orientation (e.g., upright, on an angle, upside-down, etc.), in the interest of simplifying this explanation, relative directions and juxtapositions (e.g., top, bottom, left, right, above, etc.) will be indicated assuming the orientation illustrated in FIGS. 1 and 2.

The present invention will now be described in detail with reference to the figures, which show preferred light configurations. Referring to FIGS. 1-3, a first exemplary light assembly 20 includes a mounting member 28, an electronics housing member 26, a cover member 24, electronic driving circuitry 36 and three separate optical modules including an upper module 38a, a middle module 38b and a lower module 38c. Referring to FIGS. 1 and 2, mounting member 28 is generally a cylindrical rigid plastic member which forms an upwardly facing surface 37 and some type of mechanical structure for mounting assembly 20 to a truck, sign, or some other support structure. In the illustrated embodiment surface 37 forms an annular upwardly facing recess 39 about its circumference for receiving a similarly shaped lower edge of member 26. In addition, member 28 forms a central aperture 30 sized to mount a grommet 32 through which electrical wiring 34 is passed from below to above surface 37.

Circuitry housing member 26 is an annular rigid plastic member that, in some embodiments, may be translucent. Member 26 forms upper and lower annular edges 27 and 29, respectively. Lower edge 29 is dimensioned to be received within recess 39. When member 26 is mounted to member 28, members 26 and 28 together form a cavity 41 for receiving/protecting circuitry 36. In at least some embodiments (see FIG. 2), ledges 100 extend from an internal surface of member 26 and form at least partially upwardly facing surfaces 114 for supporting modules thereabove as described in greater detail below. Members 26 and 28 may be secured in any of several different ways including ultrasonic welding, epoxy, cooperating threads or some other type of mechanical couplers.

Circuitry 36 includes standard circuitry for driving light emitting devices. To this end, circuitry 36 generally will include some type of power transformer to condition energy received via cables 34 and produce suitable currents for causing LEDs or the like to flash. In addition, circuitry 36 also includes a timer device (not labeled) for identifying when current pulses should be provided to the emitting devices to cause flashing activity.

In addition to the components described above, in at least some embodiments, circuitry 36 will also include linking terminals that are specifically juxtaposed so as to receive distal ends of electrical leads that extend from modules 38a, 38b and 38c thereabove. In this regard it is contemplated that, in one embodiment, the electrical connections to provide power to the light emitters will be rigid and relative juxtapositions will be set. For example, referring to FIGS. 2 and 6, in an assembly including three modules 38a, 38b and 38c where each module includes a pair of leads 52 that extend in opposite directions and where the leads corresponding to each module are angularly offset by 20° from the leads corresponding to the other modules, terminals or receiving ports (e.g., two identified by numeral 53 in FIG. 2) formed on a circuit board substrate 55 will be arranged in a similar pattern to facilitate easy linkage.

In addition, in at least some embodiments, it is contemplated that a single electronics driving package 36 may be provided for driving various assembly configurations. For example, in one case where circuitry 36 includes an arrangement of six linking terminals 53 for accommodating a maximum of three modules (e.g., 38a), an assembler may have the option to configure an assembly having only one or two of the modules using the same six terminal circuitry. Where only two modules are employed, only four of the linking terminals 53 would be used and the remaining two terminals would remain disconnected upon assembly. Similarly, where only one module 38c is employed, only two of the linking terminals would be used.

Referring still to FIGS. 1 and 2, cover 24 is generally an inverted cup shaped member formed of translucent rigid plastic that defines a cavity 25 and a lower annular edge 59. Edge 59 is dimensioned to be essentially identical to edge 27 formed by member 26 and, upon assembly, is secured thereto in any known manner. For instance, in some cases ultrasonic welding may be employed to secure edge 59 to edge 27. Ledges 110 extend inwardly from the distal end of cavity 25 and from surfaces 112 that at least in part face downward and that at least in part oppose surfaces 114 upon assembly of light components. The dimension formed between surfaces 112 and opposing surfaces 114 is precise and in some embodiments is designed to be a multiple of module dimensions aligned therewith upon assembly. The specific surface to surface dimension is important in some embodiments because module components are held together via a clamping action described in greater detail below.

In at least some embodiments each module 38a, 38b and 38c is essentially identically constructed and therefore, in the interest of simplifying this explanation, only module 38c will be described here in detail. Referring to FIGS. 2, 4 and 5, module 38c includes an intermediate support member 42, a heat sink member 44, an LED 46 and associated circuit board 56, threaded fasteners 48, an optical element 50 and two elongated electrical leads 52. The LED 46 includes an acrylic lens 54 mounted over a diode (not shown) that is linked to small circuit board 56 which is in turn linked to leads 52. The diode is selected to provide a particular light intensity. More specifically, in at least some embodiments, each diode is selected to independently provide enough radial light to meet or exceed SAE classification 1 intensity requirements for flashing lights. Note that when so selected, because SAE classifications 2 and 3 correspond to intensities that are twice and three times of the classification 1 intensity, the combined intensities of two and three modules can be used to meet classification 2 and classification 2/3 requirements, respectively. The LED lens 54 is selected by color. Conventional LEDs are available in red, amber, white, blue and green.

Referring to FIGS. 2, 5, 6 and 8, support member 42 is generally a cylindrical member having a cylindrical side wall or surface 64 and generally oppositely facing first and second surfaces 62 and 63, respectively. First surface 62 forms a central recess or opening 60 and includes two radially inwardly extending tabs 57 (see FIG. 8) that extend toward each other. Each tab 57 forms at least one threaded aperture (not numbered) for receiving the distal end of one of screws 48.

First surface 62 and side surface 64 form three pairs of groves or channels 68, 70 and 72 that are sized to receive electrical leads therein and to direct leads toward driving circuitry linking terminals 53 in cavity 41. Groove pairs 68, 70 and 72 are radially offset from each other about central axis 40. More specifically, groove pairs should be offset by at least a few (e.g., 5-20) degrees from each other to minimize shadowing from the leads at particular locations about light 20 to improve light intensity uniformity. In this regard it should be appreciated that when an electrical lead or conductor 52 is positioned between a light source and a specific observing location to the side thereof, the lead reduces the intensity of light sensed at the specific observing location. SAE standards require that intensity requirements for flashing lights be met at all observing locations and therefore, even a slight reduction in intensity due to an intermediate lead may cause an assembly to fail to meet SAE standards. By offsetting the leads 52 as in at least some embodiments of the invention, despite the fact that each lead may impede light from some elements 50 to certain observing locations, light from other elements 50 will not be impeded and the net result will be that the combined light at all observing locations will more easily meet the regulatory requirements. For instance, referring to FIG. 1, while lead 52a impedes light from elements 50b and 50c at an observing location radially aligned therewith, lead 52a does not impeded light from element 50a. Similar comments are applicable to the other leads 52 in the illustrated embodiment.

Referring again to FIGS. 6 and 8, the sections of groove pairs 68, 70 and 72 formed by first surface 62 are not all used. More specifically, in at least some embodiments, sections of only one pair 68, 70 and 72 formed by the first surface 62 receive electrical leads. In this regard, the leads of the lower, middle and upper modules 38c, 38b and 38a as illustrated in FIG. 2 are received in the sections of groove pairs 68, 72 and 70 formed by first or top surface 62, respectively. When light 20 is assembled, the sections of groove pairs 68, 72 and 70 formed by side surfaces 64 are aligned so that leads from more than one module 38 may pass therethrough. For example, the leads from upper module 38a pass through all of the sections of groove pairs 68 formed by side surfaces 64, leads from middle module 38b pass through sections of groove pairs 72 formed by side surfaces 64 of the middle and lower support members 42 and leads from lower module 38c pass through sections of groove pairs 70 formed by the side surface 64 of support member 42 only.

It should be noted that mounting members 42 need not be formed of multiple sets of grooves in top surface 62 and, at least some of the support members in a light including more than one module 38 need not form all of the grove pairs in the side surfaces 64. For instance, because leads 52 in module 38c reside in grove pairs 68, at least the portions of groove pairs 70 and 72 formed by first surface 62 of support member 42 in lower module 38c may be omitted. Nevertheless, in at least some embodiment of the invention multiple grooves are provided in top surface 62 and side surface 64 of each support member 42 because this feature allows parts to be standardized for lighting devices having multiple optical modules and enables any one of the support members 42 to be swapped for any other support member in the assembly.

Referring to FIGS. 2, 3 and 4, second surface 63 of support member 42 forms a support member coupler which cooperates with other structures described below to align light components. In the illustrated embodiment the coupler includes an annular recess 66 formed to receive a coupler (e.g., an annular rib 87) formed by one of optical elements 50 described below.

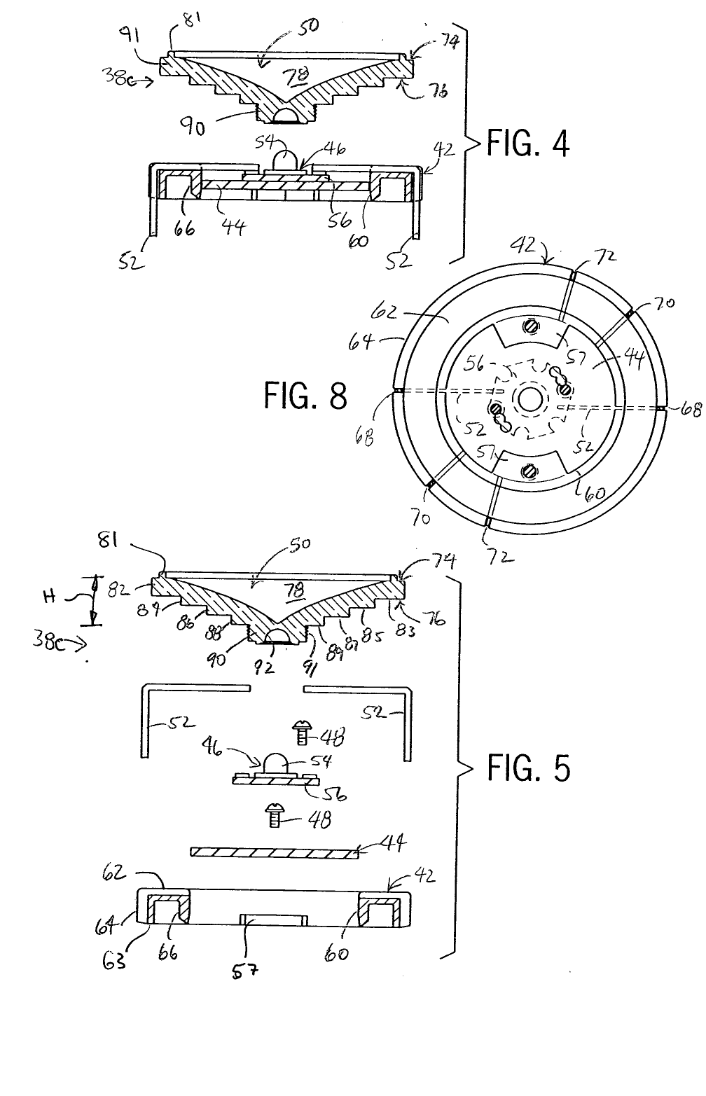

Referring to FIGS. 4, 5 and 8, heat sink member 44 is generally a planar aluminum member sized to be receivable within recess 60. At least two apertures (not labeled) are formed within member 44 for passing securing screws 48. The apertures are aligned with the holes formed in flanges 57 to facilitate attachment.

Circuit board 56 is mounted on sink member 44 and is a simple circuit for firing LED 46 linked thereto when a signal is received via leads 52 from the driving circuit in member 26.

Referring now to FIGS. 2, 4, 5, 7, 10 and 11, optical element 50 is a circular, somewhat puck-shaped, light transmissive, transparent, plastic, rigid member generally including a hub member 90 and a reflecting member 91 integrally secured to one end of the hub member 90. Reflecting member 91 includes an upper side or surface 74 and a lower side or surface 76. Upper side 74 defines a totally internally reflective (“TIR”) surface 78 that is concavely conical. Here, the phrase “concavely conical” is used to refer to a surface that may be formed by rotating a concave line through 360 degrees where one end of the line is linked to an axis of rotation and the other end of the line is linked to the circumference of rotation. While various degrees of concavity are contemplated, in at least some embodiments, the degree of concavity is determined as a function of the characteristic light emitting profile of an LED 46 or other light emitting device employed to construct module 38c. In this regard, a desirable result is for essentially equal intensities of light to be reflected radially from different similarly dimensioned sections of the height H of element 50 (See FIG. 5). Thus, for instance, where height H is dividable into four equi-dimensioned segments, in at least some advantageous embodiments, equal light intensities emanate radially from each segment. Other concavities are contemplated that yield similar results (e.g., the difference in intensities between sections may be 30-40% in some cases).

Upper side 74 also defines a raised circular alignment rib 81 projecting upward in a direction away from lower side 76. Alignment rib 80 is sized so that it fits just inside of the inner diameter of channel 66 at the underside of mounting member 42.

The lower side 76 of each reflecting member 91 has a decreasing stepped diameter defining four lateral or window surfaces 82, 84, 86 and 88 (and corresponding annular radial surfaces 83, 85, 87 and 89) of decreasing surface area and a hub member 90, all of which are concentric with a central axis 40. The window surfaces 82-88 are generally smooth cylindrical surfaces that are essentially parallel to central axis 40.

Hub or hub member 90 is generally cylindrical and has several important features. First, in at least some embodiments, the external surface of hub 90 forms a plurality of triangular extension members that wrap annularly therearound and that together form a fresnel surface about hub 90. The fresnel surface is designed so that light within hub 90 that is directed toward the external surface of hub 90 from a source positioned therein is directed substantially radially outward from the hub with minimal internal reflection. The mean diameter of hub 90 is less than a diameter formed between central axis 40 and lateral surface 88.

Second, an undersurface of hub 90 comprises a light receiving surface opposite reflecting member 91. In at least some embodiments the light receiving surface forms a recess 92 for receiving a light source (e.g., LED 46). In some embodiments recess 92 is formed to snugly receive an LED. In other embodiments recess 92 may be formed to be larger than the volume required to receive an LED (e.g., twice the volume required). In most embodiments the contour formed by recess 92 should be such that substantially all light generated by the source received therein passes into element 50. In at least some embodiments recess 92 extends substantially to the end of hub 90 from which reflecting member 91 extends.

In some embodiments the external surfaces of member 91 are formed such that all light entering member 91 from within recess 92 first subtends the reflecting surface and then is re-directed back into member 91 and out the lateral surfaces. Here where recess 92 extends substantially along the length of hub member 90, a particularly flat element 50 results (i.e., an element that has a minimal dimension along central light axis 40). For many applications a flat element 50 is particularly advantageous as, when stacked with other members 50 to form a strobe light or the like, the overall height of the light can be minimized.

Third best seen in FIG. 11, standoffs 94 depend down from the bottom of the hub 90. Standoffs 94 are provided to contact an upward facing surface of circuit 56 upon assembly and are dimensioned relative to the source 46 dimensions and recess 92 dimensions so that, while source 46 fits snuggly within recess 92, most if not all of the force between element 50, source 46 and circuit 56 when element 50 is pressed against circuit 56 is absorbed by standoffs 94 and the facing surface of circuit 56 and minimal force if any is applied to source 46.

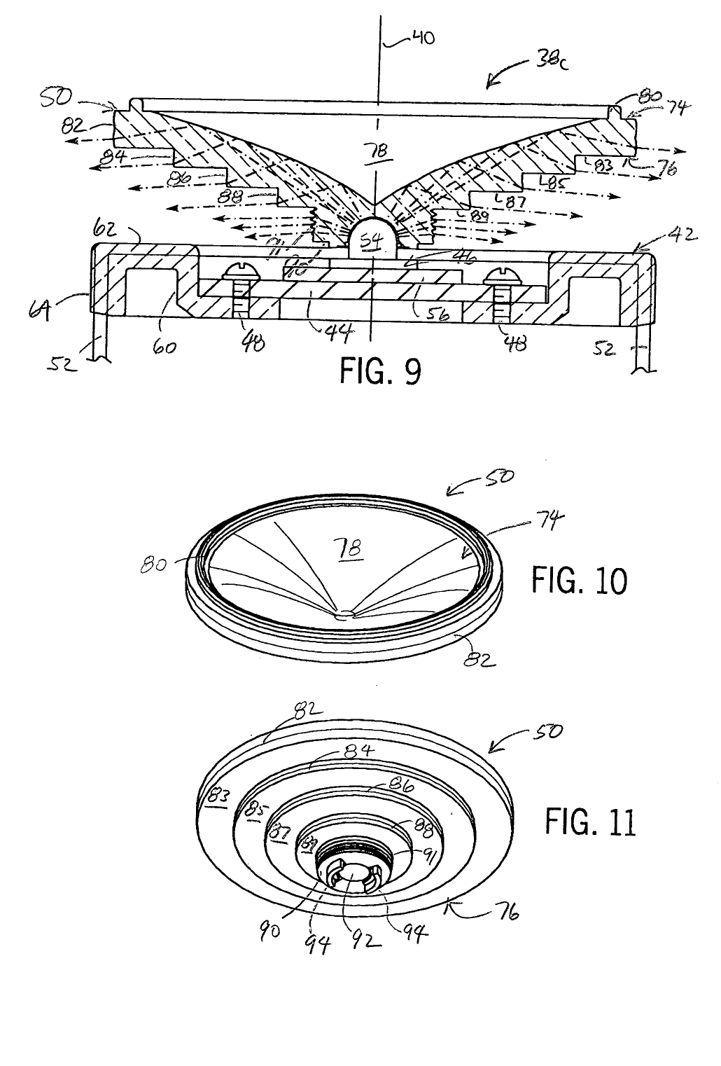

Referring now to FIG. 9, LED lens 54 is generally dome-shaped so that light emitted thereby disperses in a somewhat hemispherical or bell shaped pattern. Optical element 50 is designed to redirect light that is initially along trajectories that are at least partially aligned with central axis 40 so that the light is emitted radially from element 50. In this regard, light from LED 46 passes into element 50 through hub 90. A portion of the light passing into element 50 that is not directed at the fresnel surface of hub 90 is totally internally reflected off reflecting surface 78 and back through element 50. The reflected light either passes out element 50 directly through one of lateral window surfaces 82-88 (as shown in FIG. 9) or is again internally reflected off of the radial surfaces 83-89, one or more times, before being emitted through the lateral window surfaces 82-88.

Essentially all of the light passing into element 50 that is directed the fresnel surface of hub 90 exits element 50 without being internally reflected.

Prior to assembling a light according to the present invention, an assembler determines the lighting requirements such as, most importantly, the intensity of light required from the assembly to be configured. Thus, where each module 38a-38c separately meets the SAE classification 1 intensity requirements for flashing light, assuming an assembly that meets the classification 3 intensity requirement is to be assembled, the assembler would select three modules 38a-38c and a corresponding cover 24 that is suitable to house three modules.

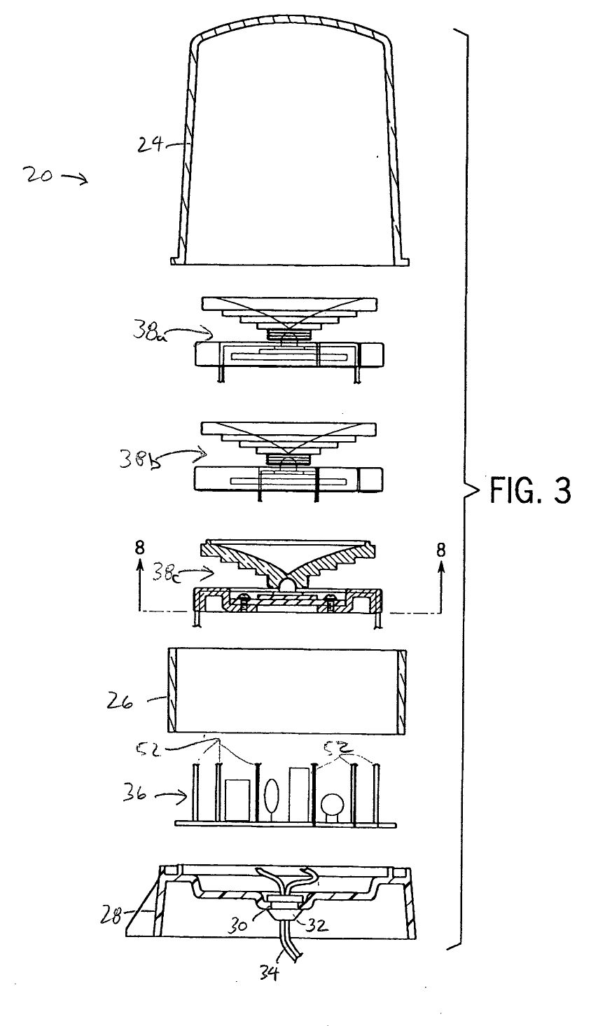

After components have been selected a light according to at least some embodiments of the invention can be assembled by stacking the selected optical modules 38a, 38b and 38c one on the other as illustrated in FIGS. 2 and 3 so that all of the modules are centered along the central axis 40. In this regard, according to at least one method, lower module 38c is first placed on surfaces 114 as illustrated in FIG. 2. Here, although not illustrated, a rib similar to rib 81 formed by the top surface 74 of each of elements 50 may be formed by surfaces 114 that is receivable within recess 66 to help center module 38c on axis 40. Next, middle module 38b is stacked on top of lower module 38c with the rib 81 formed by element 50c received in the annular recess 66 formed by the undersurface of support member 42b. Continuing, upper module 38a is stacked on top of middle module 38b with the rib 81 formed by element 50b received in the annular recess formed by the undersurface of support member 42a.

Each time a module is added to the stack, the electrical leads 52 extending down from the module are aligned with separate ones of the linking terminals 53 similarly juxtaposed on the upward facing surface of board 55 and are linked to the leads in some secure fashion. For example, leads 52 may be linked to terminals 53 via soldering, some type of mechanical spring function or clamping device, etc.

Next, cover 24 is placed over the module stack such that surfaces 112 formed by ledges 110 contact the top surface 74 of the optical element 50a. When so positioned, cover 24 is dimensioned so that the lower edge thereof just rests on a facing similarly shaped edge of member 26 such that when the two facing edges are secured together, surfaces 112 and 114 place a compressive force on the modules therebetween and maintain the relative juxtapositions thereof. Cover 24 and member 26 may be secured in any of several fashions including epoxy, sonic welding, etc.

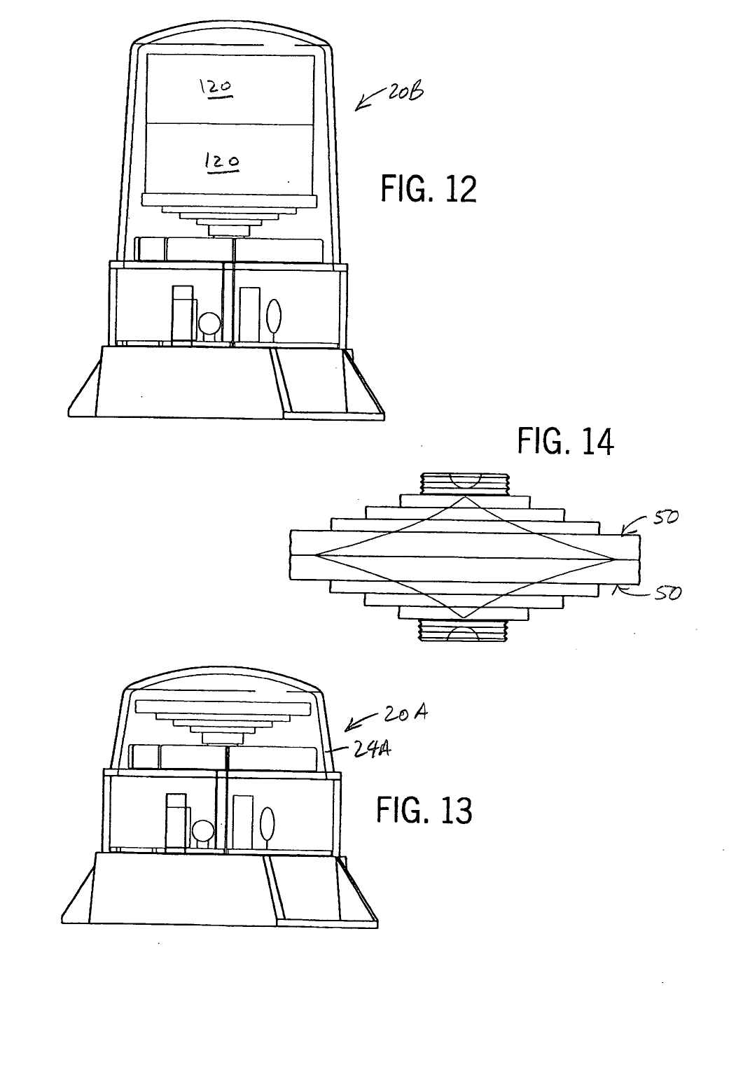

As indicated above, in at least some embodiments of the invention the entire assembly 20 is modular. For example, one or more optical modules can be used with a single size cover 24 or with covers of different sizes. For instance, as shown in FIG. 13, a light assembly 20A may be configured with a smaller cover 24A specifically sized for one optical module. Although not shown, another cover may be sized to compressively accommodate two optical modules, four modules, etc. As shown in FIG. 12, a light assembly 20B may have one size cover used for any number of optical modules, in which case spacers 120 may be provided to occupy the interior volume between the distal internal surface of the cover and the optical module(s) thereby still permitting the optical module(s) to be assembled by clamping the cover to the base member (e.g., edge 27).

Another benefit of the modularity of the inventive light is that a large number of other housing configuration and module mounting configurations may be designed to meet requirement for other common applications. For instance, housings designed for less than 360 degree light dispersion (e.g., lighting the area between two interior or exterior sides of a corner), may be utilized in which case the optical element could be less than circular. For instance, the optical element may define a sector of a circular or a rectilinear structure. Broadly stated, either or both of the housing and the optical element(s) could be circular or non-circular in cross-section without deviating from the scope of the invention. A non-circular housing could contain several circular optical modules, as described herein, however rather than being stacked along a central axis, the modules may be staggered vertically and/or horizontally to occupy the interior space of the housing as needed to provide the desired lighting effect. Moreover, the modules could be arranged so that their optical elements 50 are stacked in opposing relation as illustrated in FIG. 14.

Thus, it should be appreciated that only a few embodiments of the invention have been described above and that many modifications and variations to the described embodiments will be apparent to those skilled in the art. Therefore, the invention should not be limited to the described embodiments above. For example, while the concepts above are particularly suitable for use with a LED type light emitting source 46, is contemplated that many of the concepts above would also be useful in the context of other types of light emitting devices such as an incandescent light bulb. In this regard, the stacking concept above where a plurality of incandescent light bulbs are stacked together to provide different light intensities to meet different regulatory requirements can be used with an incandescent type light bulb. As another instance, an incandescent light bulb may be used with the radially directing optical elements described above. In addition, while embodiments described above include modules held together by way of a compressive force between at least partially facing surfaces formed by a cover and some type of base member to which the cover mounts, it should be appreciated that other concepts may be used to hold light components and, specifically, modules, together. In this regard, it is contemplated that many different mechanical devices may be used to hold the modules together. To ascertain the full scope of the invention, the following claims should be referenced.

Moreover, while the invention is described above as one wherein single LEDs or other light emitting sources are used with each one of the modules, it is contemplated that, in at least some embodiments, more than one LED may be provided within each module. In this regard, in at least one other embodiment, a single central LED may be provided with several (e.g., five) other LEDs substantially equi-spaced about the central LED where each of the six LEDs is received within a different recess formed by an undersurface of the optical element hub. Here, while a radial disbursing effect may not be identical from all angles about the element, the overall effect may be to provide a light configuration that meets either the classification 2 or classification 3 SAE lighting requirements using a single module as opposed to multiple modules.

Furthermore, while the present invention includes a cover member 24, in at least some embodiments no cover member would be provided. In addition, where an LED having a different dispersing pattern is employed, elements 50 may take a different form. For instance, in the case of an LED that has dispersion characteristics that disperse light more radially, the height dimension H of each element 50 may be reduced to accommodate the characteristic and result in an element that still directs the Yeoman's share of light radially.

In addition, in some embodiments the support elements 42 may not include grooves for leads 52. In some cases where the light emitters are intense enough the leads 52 need not be staggered.

With respect to assembly, other methods are contemplated such as, for instance, stacking the modules (e.g., 38a-38c) before placing the lower module 38c on surfaces 114 or, stacking the modules within cover cavity 25 prior to linking to linking terminals 53.

In some embodiments modules (e.g., 38a) within one assembly may have different dimensions and dispersing characteristics. In this regard, some modules in a single assembly may have disparate heights H, may have different numbers of steps formed by the undersurfaces of the optical elements, may have different radii between the lateral surfaces and the central axis and so on.

In addition, it has been recognized that some side emitting LEDs have been designed that, in essence, direct light laterally or radially through 360 degrees. In these cases, the light guide elements described above may be altered so that side emitted LED light passes radially through the guides and exits radially to provide an effect similar to that described above. In this case the side emitting LEDs and ring shaped guide elements may be stacked in a relatively short configuration and still provide standard light emitting requirements. In fact, in some embodiments side emitting LEDs may be stacked along a single central axis without guides to configure some particularly small strobe light configurations.

While some of the embodiments described above include a saw tooth type fresnel surface on the exterior of hub member 90, other embodiments may include other fresnel type or refractive type surfaces such as a series of smooth ribs or recesses, a single smooth rib or other possible configurations.

To apprise the public of the scope of the invention we make the following claims.

1. An at least partially translucent optical element for distributing light from a light source, the element comprising:
a hub member formed about a central axis, having an external surface between first and second ends and forming a recess within the first end that extends along the central axis substantially along a length of the hub member between the first and second ends for receiving the source, the external surface forming a lens for dispersing light directed thereat from within the recess out of the element; and
a reflecting member integral with and extending from the second end, the reflecting member including at least one external reflecting surface that reflects substantially all of the light directed into the reflecting member from within the recess back into the element.

2. The element of claim 1 wherein the reflecting member further includes at least one lateral surface disposed laterally of the central axis, the reflecting surface directing light toward and out of the element through the lateral surface.

3. The element of claim 2 wherein the hub forms a first receiving surface at the first end and wherein the at least one reflecting surface generally faces in a direction opposite the receiving surface.

4. The element of claim 3 wherein the reflecting surface is concavely conical having an apex on the central axis.

5. The element of claim 4 wherein the lateral surface is a substantially cylindrical surface formed about and parallel to the element axis.

6. The element of claim 5 wherein the lateral surface is substantially cylindrical and the hub has a mean diameter that is less than the diameter of the lateral surface.

7. The element of claim 3 wherein the external surface of the hub forms a fresnel lens for radially dispersing light directed thereat from within the recess.

8. The element of claim 7 wherein the fresnel lens includes a plurality of triangular prism elements arranged in a circular path concentric with the central axis.

9. The element of claim 7 wherein the light passing through the lateral surface is substantially perpendicular to the central axis.

10. The element of claim 2 wherein the lateral surface is a first lateral surface and is a first dimension from the central axis and wherein the element includes at least a second lateral surface, the second lateral surface substantially cylindrical, concentric with the central axis and a second dimension from the central axis, the second dimension less than the first dimension.

11. The element of claim 10 wherein the first lateral surface is closer to the reflecting surface than the second lateral surface.

12. The element of claim 2 wherein the lateral surface is a first lateral surface and the apparatus includes a plurality of lateral surfaces, each lateral surface defining a cylinder of constant radius about the central axis, each of the cylinders having a unique radius, the radius of each cylinder less than the radii of other cylinders relatively further away from the receiving surface.

13. The element of claim 12 wherein the element further includes a plurality of additional surfaces, one additional surface between each two adjacent lateral surfaces.

14. The element of claim 13 wherein the additional surfaces are substantially flat surfaces and are substantially perpendicular to adjacent lateral surfaces.

15. The element of claim 1 for use with other elements to form an assembly wherein the reflecting surface forms an alignment coupler for aligning the element with other assembly components and with respect to the central axis.

16. The element of claim 15 wherein the alignment coupler is an extending rib that is concentric with the central axis.

17. The element of claim 1 wherein the element is plastic.

18. The element of claim 1 further including an LED as the light source.

19. An apparatus comprising:
a substantially translucent element including a plurality of external surfaces including at least one light receiving surface for passing light from a source along a plurality of trajectories into the element, at least a subset of the element surfaces juxtaposed to reflect light received through the receiving surface internally and radially outwardly from a central axis and through at least one lateral surface out of the element;
a light source juxtaposed to emit light into the element through the receiving surface when energized;
a driving circuit that includes receiving apertures that define a pattern;
substantially rigid electrical leads coupled to the source and juxtaposed with respect to each other so that the leads define the same pattern as the receiving apertures such that the leads are receivable within the apertures.

20. The apparatus of claim 19 further including a heat sink member contacting the source.

21. The apparatus of claim 20 wherein the source is mounted to the sink member and wherein the apparatus further includes a support member, the sink member mounted to the support member.

22. The apparatus of claim 21 wherein the support member forms a recessed center and the sink is mounted within the recessed center.

23. The apparatus of claim 22 wherein the support member includes a side surface and forms channels for passing electrical leads.

24. The apparatus of claim 23 wherein the support member also includes a first surface facing the element and wherein the first surface forms channels for passing the electrical leads from the source to the channels formed by the side surface.

25. The apparatus of claim 24 wherein there are two electrical leads linked to the source and wherein the side surface forms more than two channels for receiving electrical leads.

26. The apparatus of claim 22 wherein the lateral surface is substantially cylindrical and is concentric with the central axis.

27. The apparatus of claim 26 wherein the electrical leads extend from the support member in a direction away from the element.

28. The apparatus of claim 27 wherein the leads extend radially further than the lateral surface from the central axis.

29. The apparatus of claim 28 wherein the support member includes first and second substantially oppositely facing surfaces, the sink member is mounted to a first surface and the second surface forms a support coupler, the element forming an element coupler, the support member and element couplers configured to cooperate and align the support member and the element concentrically.

30. The apparatus of claim 29 wherein the support coupler includes a recess and the element coupler includes a rib receivable within a support coupler recess.

31. The apparatus of claim 30 wherein the rib is substantially annular.

32. The apparatus of claim 19 wherein the receiving surface forms a recess for receiving the source and wherein the section of the source from which light emanates is substantially received within the recess.

33. The apparatus of claim 30 wherein the lateral surface is substantially cylindrical and is concentric with the central axis.

34. The apparatus of claim 19 wherein the source is an LED.

35. An apparatus comprising:
a base member;
a translucent cover member securable to the base member so that the base member and cover form a cavity;
driving circuitry mounted to the base member;
at least one optical module mounted within the cavity, the module including:
a substantially translucent element including a plurality of external surfaces including at least one light receiving surface for passing light from a source along a plurality of trajectories into the element, at least a subset of the element surfaces juxtaposed to reflect light received through the receiving surface internally and substantially radially outwardly from a central axis and through at least one lateral surface out of the element; and
a light source juxtaposed to emit light into the element through the receiving surface when energized.

36. The apparatus of claim 35 wherein the cover and the base member have at least partially facing surfaces and wherein the optical module components are juxtaposed within the cavity such that the at least partially facing surfaces clamp the module components together.

37. The apparatus of claim 35, wherein the cover member is sonically welded to the base member.

38. The apparatus of claim 35 wherein the optical module is a first optical module and wherein the apparatus further includes a plurality of optical modules mounted within the cavity.

39. The apparatus of claim 38 wherein the source of the first module generates greater light intensity than the source of the other modules.

40. The apparatus of claim 38 wherein the color of the light generated by the source in the first module is different than the colors of light generated by the other modules.

41. The apparatus of claim 38 wherein the plurality includes three.

42. The apparatus of claim 38 wherein the plurality of optical modules are stacked one on top of another within the cavity so that the central axis of the modules are concentrically aligned.

43. The apparatus of claim 42 wherein at least partially facing first and second surfaces of the cover and base member clamp the modules together within the cavity.

44. The apparatus of claim 42 wherein the optical modules are identically configured.

45. The apparatus of claim 42 wherein each optical module further includes a support member, a separate support member mounted between each two adjacent elements.

46. The apparatus of claim 45 wherein each module further includes a heat sink member, each support member forms a central recess, each sink member mounted within one of the central recesses, the source in each module mounted to one of the sink members.

47. The apparatus of claim 46 wherein each support member includes a first surface that forms the central recess, the apparatus further includes electrical leads linking each of the sources to the driving circuitry, the first surface of each support member forms channels for passing the electrical leads and wherein the channels are offset from each other at different radial angles about the central axis.

48. The apparatus of claim 46 wherein each support member includes first and second substantially oppositely facing surfaces, the sink member is mounted to a first surface and the second surface forms a support coupler, each element including a reflecting surface facing opposite the sink member within the same module, the reflecting surface forming an element coupler, each support coupler configured to cooperate with one of the element couplers to align the support member and the element concentrically, the support coupler of each support member juxtaposed between elements cooperating with the element coupler of an adjacent element to align the support member and the element concentrically.

49. The apparatus of claim 35 wherein the source is an LED.

50. An apparatus comprising:
a base member;
a translucent cover member securable to the base member so that the base member and cover form a cavity;
driving circuitry mounted to the base member;
a plurality of optical modules mounted within the cavity, each module including:
a substantially translucent element including a plurality of external surfaces including at least one light receiving surface for passing light from a source along a plurality of trajectories into the element, at least a subset of the element surfaces juxtaposed to reflect light received through the receiving surface internally and substantially radially outwardly from a central axis and through at least one lateral surface out of the element;
a light source juxtaposed to emit light into the element through the receiving surface when energized; and
electrical leads linking the source to the driving circuitry.

51. The apparatus of claim 50 wherein the modules are stacked together so that the central axis of the modules align.

52. The apparatus of claim 51 wherein the electrical leads extend laterally further than the lateral surfaces from the central axis and then extend substantially parallel to the central axis toward the driving circuitry.

53. The apparatus of claim 52 wherein each lead extends along a unique radial trajectory away from the central axis.

54. The apparatus of claim 53 wherein each radial trajectory is separated from the other radial trajectories by at least 5 degrees.

55. The apparatus of claim 50 wherein the plurality includes three.

56. The apparatus of claim 50 wherein each of the lateral surfaces is substantially cylindrical and is concentric with the central axis.

57. The apparatus of claim 56 wherein each of the lateral surfaces is a first lateral surface and each of the elements includes a plurality of lateral surfaces, each of the lateral surfaces is substantially cylindrical and centered on the central axis, each of the lateral surfaces on each element defining a different dimension with the central axis.

58. The apparatus of claim 57 wherein each receiving surface forms a recess for substantially receiving the light emitting portion of a source.

59. The apparatus of claim 50 wherein the housing and base member include at least partially facing first and second surfaces and, wherein, the modules are sandwiched between the first and second surfaces to maintain their relative juxtapositions.

60. The apparatus of claim 50 wherein each of the sources is an LED.

61. A method of assembling a modular lighting device comprising the steps of:
providing a plurality of optical modules, each module including a substantially translucent element including a plurality of external surfaces including at least one light receiving surface for passing light from a source along a plurality of trajectories into the element, at least a subset of the element surfaces juxtaposed to reflect light received through the receiving surface internally and substantially radially outwardly from a central axis and through at least one lateral surface out of the element, the element emitting a known quantum of light through the lateral surface when a light source of specific intensity is juxtaposed to emit light through the receiving surface and a light source of the specific intensity juxtaposed to emit light into the element through the receiving surface when energized;
identifying a desired output light intensity to be emitted from the lighting device;
selecting a quantity of the optical modules to achieve the desired output light intensity;
linking the selected quantity of modules to a driving circuit to provide power thereto; and
placing a translucent cover over the modules.

62. The method of claim 61 wherein the driving circuitry is mounted to a base member and wherein the method further includes the step of securing the cover to the base member.

63. The method of claim 62 wherein the step of mounting the cover to the base member includes hermetically sealing the cover to the base member.

64. The method of claim 63 wherein the step of sealing includes sonically welding the cover to the base member.

65. The method of claim 62 wherein step of linking the modules to the drive circuitry includes stacking the modules together so that the central axis of the modules are concentric.

66. The method of claim 65 further including the step of providing a different cover for each selectable number of modules wherein each cover forms a first surface that at least partially faces a second surface formed by the base member when mounted thereto and, wherein, the method further includes the step of sandwiching the modules between the first and second partially facing surfaces to maintain the relative juxtapositions of the device components.

67. The method of claim 61 wherein the step of providing a plurality of optical modules includes providing modules that each also include a heat sink member linked to the source to dissipate heat.

68. The method of claim 61 further including the step of arranging the optical modules so that each element is observable from every radial angle about the central axis of the elements.

69. The method of claim 68 wherein the sources are substantially identical, one module generates enough radially emitted light to meet an SAE classification 1 intensity requirement, two modules generates enough radially emitted light to meet an SAE classification 2 intensity requirement and three modules generates enough radially emitted light to meet an SAE classification 3 intensity requirement.

70. A method of assembling a modular lighting device comprising the steps of:
providing a plurality of optical modules, each module emitting a known quantum of light along trajectories substantially perpendicular to a central axis and through a lateral surface when power is provided thereto;
identifying a desired output light intensity to be emitted from the lighting device;
selecting a quantity of the optical modules to achieve the desired output light intensity;
stacking the selected modules with their central axis aligned; and
linking the modules to a power source to provide power thereto.

71. The method of claim 70 wherein the step of providing modules includes providing modules where each module includes a substantially translucent element including a plurality of external surfaces including at least one light receiving surface for passing light from a source along a plurality of trajectories into the element, at least a subset of the element surfaces juxtaposed to reflect light received through the receiving surface internally and radially outwardly from a central axis and through at least one lateral surface out of the element and a light source juxtaposed to emit light into the element through the receiving surface when energized.

72. The method of claim 70 further including the steps of providing a plurality of substantially transparent covers wherein each cover is configured to accommodate a different number of optical modules, selecting a cover to accommodate the selected quantity of optical modules and placing the cover over the stacked modules.

73. The method of claim 70 wherein each module has an axial dimension along the central axis, the method further including the steps of providing a cover for at least N stacked modules and spacers wherein at least a subset of the spacers have axial dimensions identical to the axial dimensions of the modules, the step of selecting a quantity of modules including selecting M modules where M is less than N and the method further including stacking N-M spacers along with the selected modules and then placing the cover over the spacer and module stack.

74. A method of assembling a modular lighting device comprising the steps of:
providing a plurality of optical modules, each module emitting light along known trajectories;
selecting a quantity of the optical modules to achieve the desired lighting effect;
stacking the selected modules together in a pattern to achieve the desired lighting effect;
linking the modules to a power source to provide power thereto; and
providing a housing assembly about the stacked modules that compressively holds the modules together in the stacked configuration.

75. An apparatus comprising:
a plurality of light sources, each source generating light along trajectories that fan out about a central light axis; and
a mounting structure for mounting the light sources such that the light axis are parallel to a central axis that has an axis length dimension and such that the sources are adjacent different locations along the axis length dimension.

76. The apparatus of claim 75 wherein the light axis are arranged along the central axis.

77. The apparatus of claim 75 further including a plurality of light guide elements, one element for each source, each element positioned with respect to an associated source such that at least a portion of light from the source that enters the element is directed substantially radially away from the central axis.

78. The apparatus of claim 77 wherein each element directs substantially all of the light from an associated source substantially radially.

79. The apparatus of claim 78 wherein each element includes at least one reflective surface for internally reflecting light directed thereat along trajectories substantially perpendicular to the central axis.

80. The apparatus of claim 76 wherein each light source is an LED.

81. A method comprising the steps of:
providing a plurality of light sources, each source, when energized, generating light along trajectories that fan out about a central light axis;
mounting the light sources such that the light axis are parallel to a central axis that has an axis length dimension and such that the sources are adjacent different locations along the axis length dimension; and
linking the sources to a driving circuit to provide power thereto.

82. The method of claim 81 wherein the step of mounting includes mounting the sources so that the light axis are aligned along the central axis.

83. The method of claim 81 further including the steps of providing a plurality of light guide elements, one element for each source, positioning each element with respect to an associated source such that at least a portion of light from the source that enters the element is directed substantially radially away from the central axis.

84. The method of claim 82 wherein the step of providing elements includes providing elements that direct substantially all of the light from a source at a specific point with respect thereto substantially radially away form the central axis and wherein the step of positioning each element includes positioning the element so that the associated source is at the specific point with respect thereto.

85. A strobe light comprising:
a plurality of LEDs, each LED generating light along trajectories that fan out about a central LED axis;
a support structure for mounting the LEDs such that the LED axis are aligned along a central axis;
a driving circuit for driving the LEDs, the driving circuit linked to each LED to provide power thereto; and
a housing assembly including a base member and a cover member that together form a cavity, the LEDs and support structure mounted within the cavity.

86. +The light of claim 85 further including a plurality of light guide elements, one element for each LED, each element positioned with respect to an associated LED such that substantially all of light from the LED that enters the element exits the element along trajectories that are substantially radially away from the central axis.
